(19) United States
(12) Patent Application Publication
(10) Pub. No.: US 2026/0178152 A1
(43) Pub. Date: Jun. 25, 2026

(54) Book with Audio Output and Recording Function

(71) Applicant: JAST Gifts Shenzhen Company Limited, Shenzhen City (CN)

(72) Inventor: Jen-Lin Chen, Cupertino, CA (US)

(21) Appl. No.: 19/538,955

(22) Filed: Feb. 12, 2026

Related U.S. Application Data
(63) Continuation-in-part of application No. 18/776,199, filed on Jul. 17, 2024, now abandoned.

(30) Foreign Application Priority Data
Dec. 28, 2023 (DE) 10 2023 136 771.4

(51) Int. Cl. G06F 3/044

(52) U.S. Cl. CPC G06F 3/044

(57) ABSTRACT

A book assembly with internal electronics, a front cover, a rear cover, and at least one page. Touch sensors are disposed within the book. A microphone and speaker are supported by the book assembly. The book assembly records and stores custom audio files made via the microphone. The book can also hold preset audio files that come with the book assembly. At least one control switch is accessible on the book structure for selecting between a recording mode and a play mode. In the recording mode, custom audio files are recorded for each touch sensor. The custom audio recording is assigned to the touch sensor that is activated at the time of the recording. After the recording, the circuitry plays the custom audio file assigned to a touch sensor when the touch sensor is activated. In alternate operational modes, the touch sensors can trigger the playing of preset audio files.

### RELATED APPLICATIONS

This application is a continuation-in-part of U.S. patent application Ser. No. 18/776,199 filed Jul. 17, 2024.

### BACKGROUND OF THE INVENTION

### 1. Field of the Invention

The invention relates to a book with an audio output and a recording function. In particular, the invention relates to a book that has a digital recording and an audio output function that can be intuitively operated by means of sensors.

### 2. Prior Art Description

Books in which a digital audio output function is integrated are known in the prior art. Likewise, there are books known to have a recording function in addition to the audio output. Thereby, the output of an audio file or the recording of an audio file is usually triggered by pressing a sensor, wherein each sensor is assigned a specific memory size.

When a new audio file is recorded, the file originally found in the memory location is overwritten. If a larger memory space is required for a specific recording than is allocated to the corresponding sensor, the recording is ended when the maximum memory capacity allocated to such sensor is reached, although the memory spaces allocated to the other sensors may still have capacity available.

A disadvantage of the known audio books with recording function is, on one hand, that the built-in memory is not flexibly available. On the other hand, the number of audio files is limited to the extent that the originally intended recording is overwritten by a new audio recording and is subsequently no longer available.

In addition, the operation of such an audio book should be affected as intuitively as possible and the recording method should be as simple as possible.

It is therefore the object of the invention to provide a book with an audio output and a recording function that enables variable memory allocation and with which, in addition, an existing audio recording is not overwritten by the recording function.

Furthermore, it is the object of the invention to provide a book with an audio output and a recording function, which enables intuitive operation of the audio book through particularly simple operability, in particular for creating audio recordings.

These objects are achieved by a device with the features of Claim 1. Advantageous embodiments are the subject matter of the dependent claims. It should be noted that the features listed individually in the claims can also be combined with one another in any technologically expedient manner and thus demonstrate further embodiments of the invention.

### SUMMARY OF THE INVENTION

The present invention is a book assembly with internal electronics and its method of operation. The book assembly has the structure of a book with a front cover, a rear cover, and at least one page. A plurality of touch sensors are provided within the book with at least some of the pages containing a touch sensor. A microphone and speaker are supported by the book assembly and are usable with the book assembly when the book is either open or closed.

The book structure has a memory that is partitioned into both RAM circuitry and ROM circuitry. The RAM circuitry can retail audio recordings that are dynamically generated by a user. The ROM circuitry contains preset audio files that are factory set. One or more control switches are provided on the book structure. The control switch/switches can be selectively configured into a first setting, a second setting, and a third setting in addition to an “off” setting. When the control switch/switches are in the first setting, one of the preset audio files is played over said speaker each time one of the touch sensors is activated. When the control switch/switches are in the second setting, audio is recorded in the random access memory each time one of said touch sensors is activated, therein creating self-recorded audio files. Lastly, when the control switch/switches are in the third setting, one of the self-recorded audio files is played each time one of the touch sensors is activated.

Each self-recorded audio file is assigned to the touch sensor that is activated at the time the self-recorded audio file is recorded. After the recording, circuitry plays the self-recorded audio file assigned to a touch sensor when the touch sensor is activated.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is schematic view of the front side of an exemplary book assembly;

FIG. 2 is a rear view of the embodiment of FIG. 1;

FIG. 3 shows an inside view of the exemplary embodiment with the electronics arranged therein;

FIG. 4 is a schematic view of the book according to the invention in a partially opened state;

FIG. 5 is a block diagram illustrating some of the method of operation for the present invention;

FIG. 6 is a block diagram illustration showing the logic of the control switch settings; and

FIG. 7 shows charts that outline the management of the dynamic memory.

### DETAILED DESCRIPTION OF THE DRAWINGS

Although the present invention book assembly can be embodied in many ways, only one exemplary embodiment is illustrated. The exemplary embodiment is being shown for the purposes of explanation and description. The exemplary embodiment is selected in order to set forth one of the best modes contemplated for the invention. The illustrated embodiment, however, is merely exemplary and should not be considered a limitation when interpreting the scope of the appended claims.

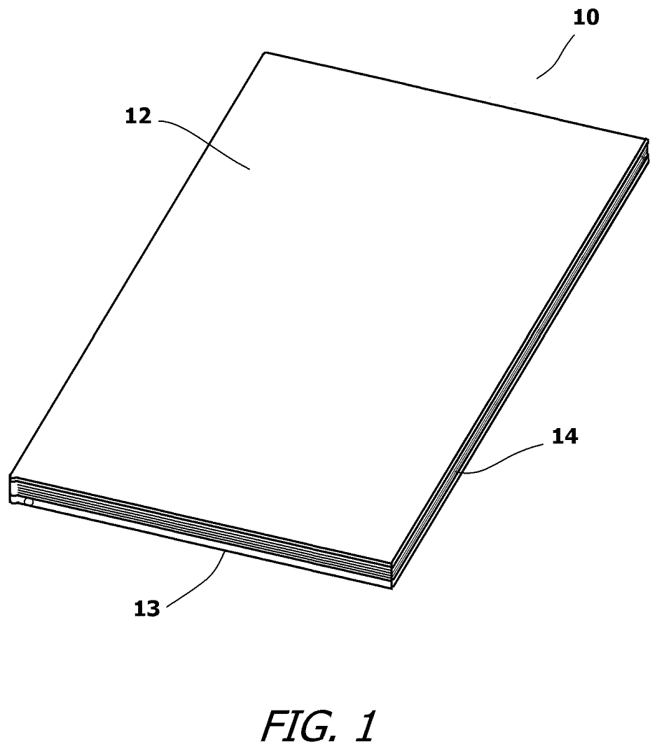

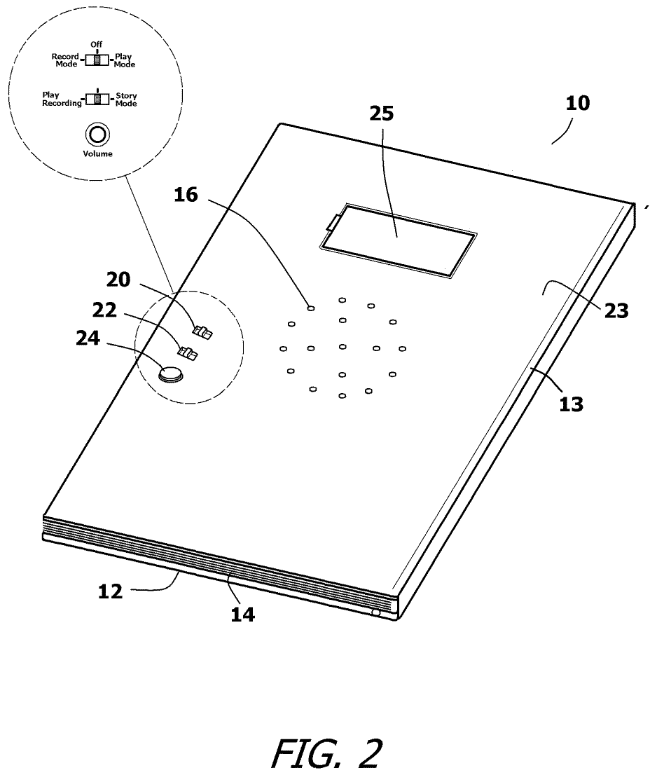

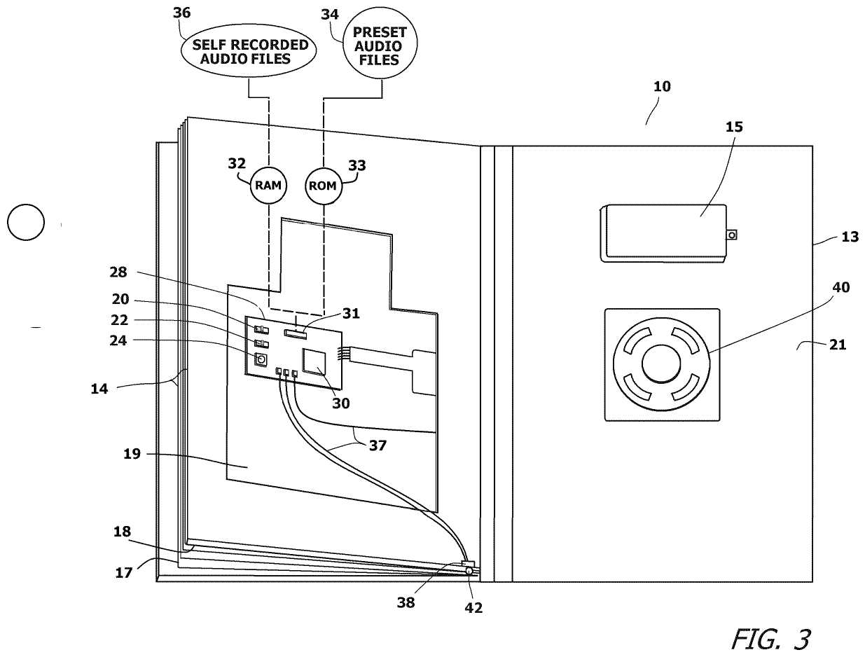

Referring to FIG. 1, FIG. 2 and FIG. 3, a book assembly 10 is shown that contains a front cover 12, a plurality of book pages 14, and a rear cover 13. The front cover 12 is a traditional cover and may contain the graphics and title of a book. The book pages 14 have a laminated structure that is later described. The book pages 14 include a first page 17 and a last page 18. The first page 17 is adjacent the front cover 12 of the book assembly 10. An electronics compartment 19 is interposed between the last page 18 of the book assembly 10 and the rear cover 13. The rear cover 13 of the book assembly 10 has an inside surface 21 that faces the electronics compartment 19 and an outside surface 23 that faces away from the book assembly 10. The outside surface 23 of the rear cover 13 contains a door 25 for accessing a battery compartment 15 within the electronics compartment 19. In addition, the outside surface 23 of the rear cover 13 contains the audio output openings 16 that lead to an internal speaker 40 within the electronics compartment 19. In this manner, when the internal speaker 40 is activated, the sound can be heard outside of the book assembly 10 regardless of whether the book assembly 10 is opened or closed. The rear cover 13 also provides access to one or more control switches. In the exemplary embodiment illustrated, there is a first control switch 20, a second control switch 22, and a volume control 24. It will be understood that the first control switch 20 and the second control switch 22 can be replaced with a single multi-position switch.

From FIG. 3, it can be seen that the electronics compartment 19 holds various electronic components. A circuit board 28 is mounted in the electronics compartment 19. The circuit board 28 contains a microprocessor 30 and a memory 31. The memory 31 is partitioned into RAM circuitry 32 and ROM memory circuitry 33. As will be explained in further detail, the ROM circuitry 33 retains audio files that are prerecorded. These can include the recorded sound of a person reading the book, music, tones, noises, or the like, and are herein referred to as preset audio files 34. The RAM circuitry 32 is capable of actively recording and storing audio sounds, such as a person reading the book aloud, which are herein referred to as self-recorded audio files 36.

Leads 37 also extend from the circuit board 28 that connect to a microphone 38 and the speaker 40. The speaker 40 is aligned with the audio output openings 16 in the rear cover 13. The microphone 38 is positioned adjacent an opening 42 at the bottom of the electronics compartment 19. In this position, the microphone 38 is accessible regardless of the number of open or closed pages 14 in the book assembly 10.

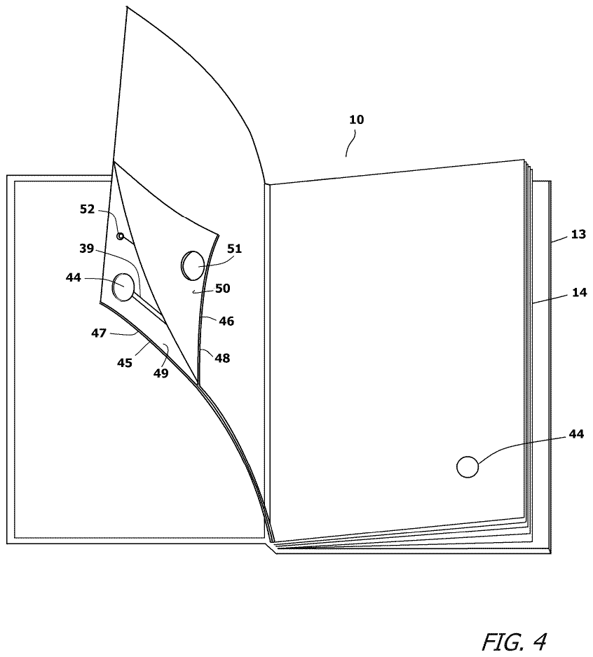

Referring to FIG. 4 it can be seen that the pages of the book assembly 10 contain touch sensors 44. The touch sensors 44 are suitable for detecting the pressure on a specific region of a book page 14. The touch sensors 44 can be capacitive pressure sensors and/or electrical contact sensors. Within the meaning of the invention, the terms “touch sensor” and “pressure sensor” are used synonymously in the art for such sensors. Here, it is particularly relevant that the touch sensors 44 are suitable for detecting a specific pressure or a specific touch of the user. In this respect, the terms “pressure” and “touch” along with “press” and “touch” are considered equivalent within the meaning of the invention. Here, it is only important that the corresponding touch sensor 44 can be triggered by being pressed or squeezed by an individual.

Each page 14 of the book assembly 10 is a laminated construct of two separate sheets 45, 46 and various sensor electronics. The two sheets 45, 46 have outward faces 47, 48 and inward faces 49, 50. The outward faces 47, 48 contain various graphics and/or words that are visible when the book assembly 10 is open and being read. The inward faces 49, 50 are glued together with the sensor electronics sandwiched between the two sheets 45, 46. The sensor electronics contain the touch sensors 44 and the wire leads 39 that connect the touch sensors 44 to the circuit board 28. Access holes 51 can be formed into the first sheet 45 and/or the second sheet 46 to provide direct access to the touch sensor 44 and to prevent the sheets 45, 46 from inadvertently compressing the touch sensors 44.

Optionally, the book assembly 10 can also include LED lights 52 on at least some of the pages 14. The LED lights 52 and their wiring can be interposed between the first sheet 45 and the second sheet 46 of each page 14 in the same manner as the touch sensors 44.

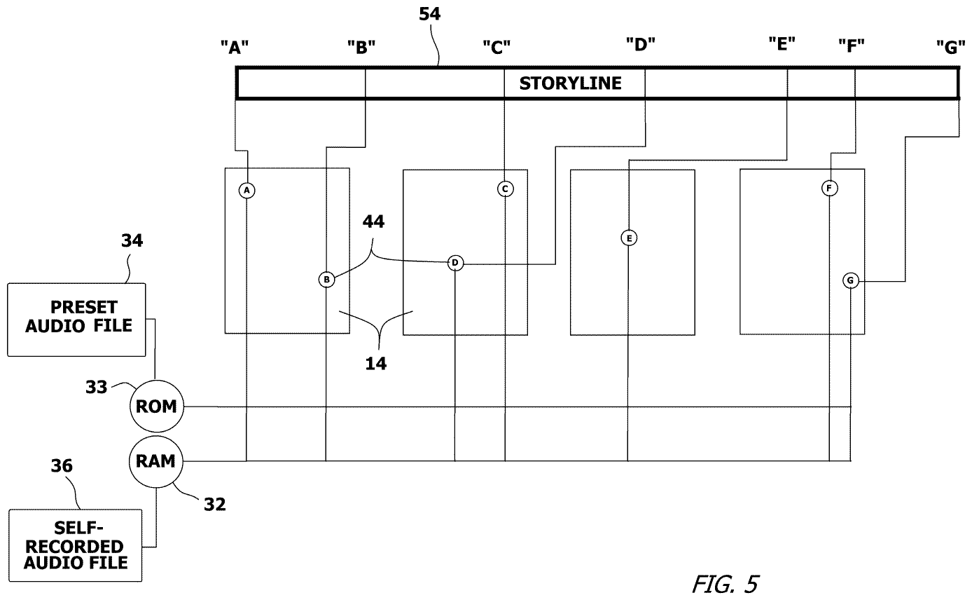

Referring to FIG. 5 it will be understood that the pages 14 of the book assembly 10 combine to produce a storyline 54. The storyline 54 has a start, an end, and a plurality of story positions between the start and the end. The story positions correspond to different pages 14, paragraphs, and/or illustrations in the storyline. In the shown example, four pages 14 are illustrated having a start at story position “A” and an end of story position “G”. Story positions “B”, “C”, “D”, “E” and “F” exists between the start story position “A” and the end story position “G”. A touch sensor 44 is provided for each story position. Since the example storyline 54 has seven positions, i.e. positions “A”, “B”, “C”, “D”, “E”, “F”, and “G”, there are seven touch sensors 44 on the pages.

The touch sensors 44 can be assigned to access files from either the ROM circuitry 33 or the RAM circuitry 32. If a touch sensor 44 is assigned to the ROM circuitry 33 and is activated, then a preset audio files 34 will play from the ROM circuitry 33. Likewise, if a touch sensor 44 is assigned to the RAM circuitry 32, then a self-recorded audio file 36 from the RAM circuitry 32 will play. It will therefore be understood that when reading/listening to the book assembly 10 an individual will hear a preset audio file 34 or a self-recorded audio file 36 when a touch sensor 44 is touched. The assignment of a touch sensor 44 to either the ROM circuitry 33 or the RAM circuitry 32 is later described. From FIG. 5, it will be understood that the full storyline 54 can be heard by sequentially pressing the touch sensors 44 as they present in the pages 14 of the book assembly 10. The full storyline 54 may contain all preset audio files 34, all self-recorded audio files 36, or a combination of both preset audio files 34 and self-recorded audio files 36.

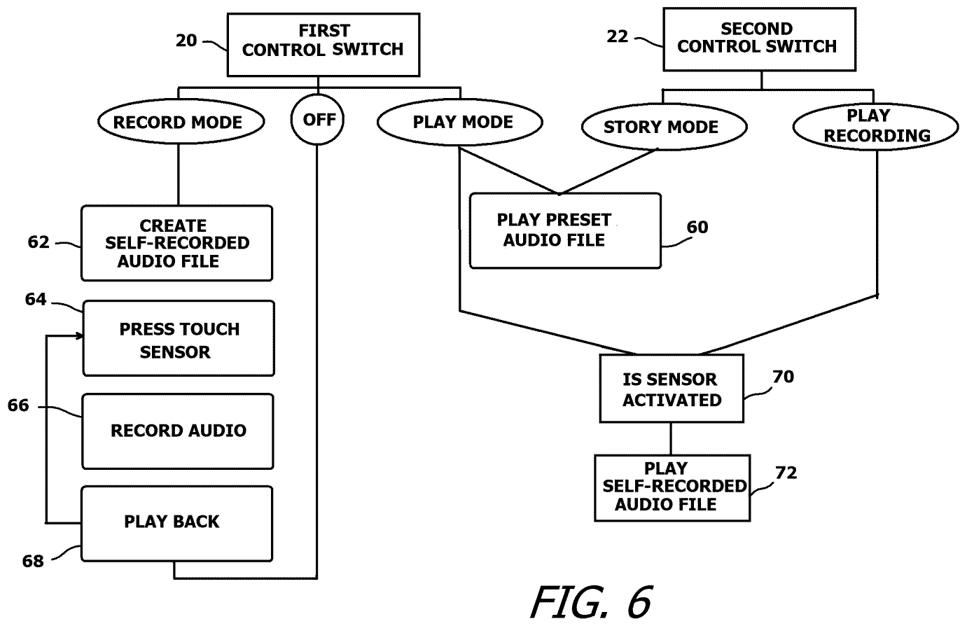

The preset audio files 34 are set at the factory and cannot be changed. However, the self-recorded audio files 36 are custom created by the purchaser of the book assembly 10. Referring to FIG. 3 in conjunction with FIG. 6, it will be understood that at least one control switch is provided on the book assembly 10. In the preferred embodiment, two control switches 20,22 are used. The first control switch 20 has three settings that correspond to three operating modes. Preferably, the three operating modes that can be selected include “Record Mode,” “Play Mode,” and “Off.” The first control switch 20 is therefore used to select if the book assembly 10 is being used to create self-recorded audio files 36 or to play mode to play self-recorded audio files 36 or play preset audio files, depends upon the setting of the second control switch 22. The second control switch 22 has two operating modes, which include “Play Recording” 36 and “Story Mode” to play preset audio files 34. As previously stated, the two control switches can be replaced with a single multi-position switch as a matter of design choice.

Each touch sensor 44 is used to assigned a preset audio file 34 or a self-recorded audio file 36 to that touch sensor 44. Each touch sensor 44 is also used to play the preset audio file 34 or the self-recorded audio file 36 that is assigned to that touch sensor 44. Assigning audio files to touch sensors 44 and playing those audio files are two separate actions. The action that occurs when a touch sensor 44 is triggered depends upon the settings of the first control switch 20 and the second control switch 22. In a first mode of operation, the first control switch 20 is positioned to the “Play Mode” setting and the second control switch 22 is set to the “Story Mode” setting. See Block 60. In this mode, the book assembly 10 plays back one of the factory recorded preset audio files 34 each time a touch sensor 44 is activated. In this manner, when the touch sensors 44 on a page 14 of the book assembly 10 are pressed, the page is read aloud, and/or sound effects are generated that complement the story setting presented in those pages 14 of the book assembly 10.

A second unique mode of operation occurs when the first control switch 20 is positioned to the “Record Mode” setting. In this mode, one self-recorded audio file 36 can be recorded for each touch sensor 44. See Block 62. This means that a separate and distinct audio recording can be created for some or all of the touch sensors 44. To record a self-recorded audio file 36 for any one touch sensor 44, a touch sensor 44 on a particular page 14 is pressed and held. See Block 64. While the touch sensor 44 is being held, the microphone 38 will record captured audio into the RAM circuitry 32. This creates a self-recorded audio file 36. See Block 66. The recording of the self-recorded audio file 36 lasts for as long as the corresponding touch sensor 44 is pressed. Alternatively, it can also be provided that the recording is started by a first press on the corresponding touch sensor 44 and ended by a second press.

After the recording has ended, the self-recorded audio file 36 is automatically played back once for checking purposes. See Block 68. If the audio recording is to be re-recorded, the above steps can be repeated as often as required. After the audio recording for each of the touch sensors 44 has ended, the first control switch 20 can be moved to the “Off” position.

In a third mode of operation, the first control switch 20 is set to its “Play Mode” position and the second control switch 22 is set to its “Play Recording” position. In this mode, the self-recorded audio file 36 recorded for any of the touch sensors 44 will play when that touch sensor 44 is activated. See Block 70 and Block 72. As such, a customized audio playback is provided for each of the touch sensors 44. The self-recorded audio files 36 are stored in the random access memory of the RAM circuitry 32. The total memory space available for self-recorded audio files 36 is dynamically distributed to the various touch sensors 44. In this manner, a flexible memory capacity is available for the self-recorded audio files 36. This enables the RAM circuitry 32 to allocate a specific memory space for storing the self-recorded audio files 36. The self-recorded audio files 36 are permanently assigned to different touch sensors 44, but the self-recorded audio files 36 are not limited in size. Rather, the memory space of the entire available RAM circuitry 32 is available to each self-recorded audio file 36. As such, the remaining memory capacity can be dynamically allocated to each touch sensor 44. A minimum memory can be reserved for each touch sensor 44 during the dynamic allocation of memory capacity, so that at least a brief audio recording is initially possible for each touch sensor 44. The book assembly 10 therefore has the advantage over the prior art in that it enables improved utilization of the installed memory, in particular due to the dynamic memory allocation. Thus, the recording of comparatively longer audio files 36 is also possible with an overall limited storage capacity. In addition, the option of managing pre-installed audio files and self-recorded audio files 36 prevents the disadvantage of known books having to overwrite the original audio file with self-recorded recordings.

It will therefore be understood that in a preferred embodiment, the electronics of the book assembly 10 contain two switches 20, 22. Two operating modes can be selected with the first switch 20, namely “Record Mode” and “Play Mode.” In the “Record Mode” custom self-recorded audio files 36 can be created and stored for each of the touch sensors 44. In the alternate “Play Mode,” the book assembly 10 will play either the preset audio files 34 or the self-recorded audio files 36 when a touch sensor 44 is activated, depending upon the setting of the second switch 22.

The second switch 22 can be used to select which audio files are to be played, namely either the preset audio files 34 or the self-recorded audio files 36. When the “Play Recording” setting is selected, the book assembly 10 will play the self-recorded audio files 36 when a touch sensor 44 is activated. Conversely, when the “Play Story” setting is selected, the book assembly 10 will play the preset audio files 34 when a touch sensor 44 is activated.

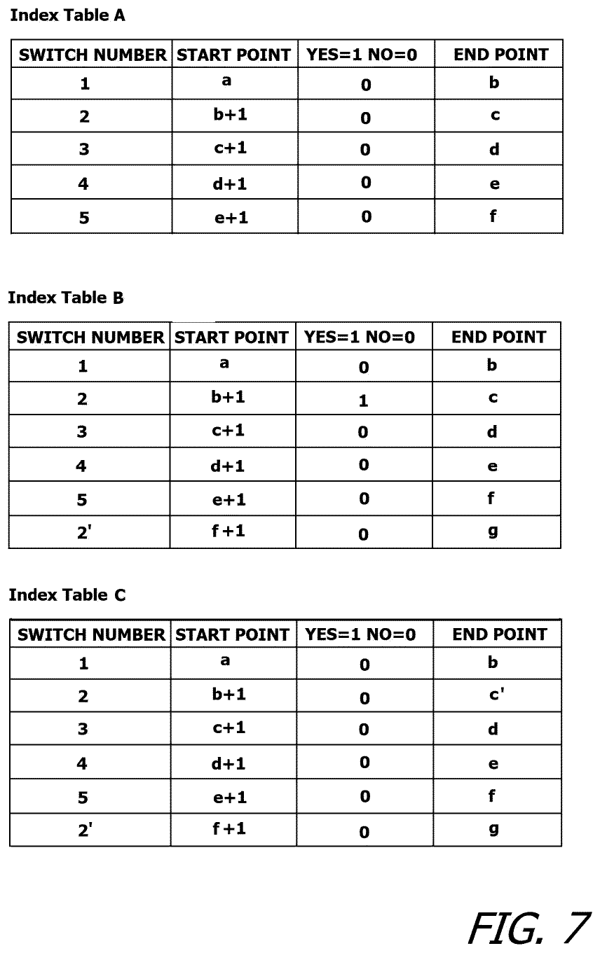

In FIG. 7, an index table is provided for dynamic memory management, in which the start point and the end point of the respective audio recording are stored. Referring to FIG. 7 in conjunction with FIG. 3 and FIG. 4, it will be understood that when a touch sensor 44 is pressed, the microprocessor 30 recognizes which touch sensor 44 was pressed and searches the index table to retrieve the corresponding audio file from the RAM circuitry 32 and plays it back. As is indicated in FIG. 7, the state of the memory is dependent upon the initial self-creation of audio files. By way of example, for a book with five pages, each page is assigned a memory location with a start point (a, b+1, c+1, d+1, e+1, etc.) and an end point (b, c, d, e, f, etc.). In addition, for each memory slot, it is noted whether it is partitioned or not (YES=1; NO=0). Based on the index table, the state of the memory after the re-recording of one or more audio files, wherein, by way of example, new audio recording 2′ (2) for page 2 is longer than originally recorded audio file 2. In such a case, more storage space is required for the audio file and the file must be partitioned.

The partition index changes accordingly from “0” to “1”. As is indicated by section B of FIG. 7, the new audio recording 2 for page 2 is longer than the original recorded audio file 2, so the new recording will start at b+1, and temporarily end at c to fully re-utilize the original memory space, mark partition to 1, to find the next available memory space, marked 2′, continued from f+1 to end g. The next available memory space g+1 is stored and saved.

As is indicated by section C of FIG. 7, the state of the memory after re-recording one or more audio files, wherein, by way of example, a new audio recording 2 for page 2′ (2) is shorter than the previously recorded audio file 2′ (2). In such a case, less storage space is required for the audio file and the file no longer must be partitioned. Accordingly, the partition index of new recording 2 changes again from “1” to “0,” and only a new end point c′ is assigned. Also, the index table 2′ (f+1, g) is cleaned. Any memory space still available between points c′ (c′+1) and c can be used for other audio files. A defragmentation program can regroup the memory at regular intervals as it progresses to eliminate partitions. After defragmentation, the index table will become as shown in section A of FIG. 7.

Referring to all figures, it will be understood that the book assembly 10 can be configured to play preset audio files 34 when a touch sensor 44 is activated. However, using the same touch sensors 44, customized recordings can also be recorded and played. To create a self-recorded audio file, the following steps are utilized.
(A) Selection of the operating mode for recording self-recorded audio files 36 using the corresponding control switches 20, 22;
(B) Opening of the book page 14 for which a self-recorded audio files 36 is to be created;
(C) Activation of the touch sensor 44 on the book page 14 for which a self-recorded audio files 36 is to be created;
(D) Recording of the self-recorded audio files 36;
(E) Optional listening to the self-recorded audio files 36 after the recording has ended;
(F) Optional repetition of steps (A) through (E) for the same or additional pages or sensors.

Once the self-recorded audio files 36 are recorded, those recordings are assigned to the touch sensors 44 and specific files are played when specific touch sensors 44 are activated.

It will be understood that the embodiment of the present invention that is illustrated and described is merely exemplary and that a person skilled in the art can make many variations to that embodiment. For instance, an interface can be provided for wireless or wired data exchange of audio files with external devices such as computers, smartphones, laptops, and tablets. It is also conceivable that specific audio files are played automatically when the book assembly is opened and other audio files are only played when a sensor is pressed. All such embodiments are intended to be included within the scope of the present invention as defined by the claims.

What is claimed is:

1. A method, comprising:
providing a book structure having book pages, touch sensors, a speaker, a microphone, and a memory, wherein said touch sensors are disposed on at least some of said book pages, and wherein said memory contains preset audio files;
providing at least one control switch that is accessible on said book structure, wherein said at least one control switch has a first setting, a second setting, and a third setting;
wherein when said at least one control switch is in said first setting, one of said preset audio files is played over said speaker each time one of said touch sensors is activated;
wherein when said at least one control switch is in said second setting, audio received by said microphone is recorded in said memory each time one of said touch sensors is activated, therein creating self-recorded audio files; and
wherein when said at least one control switch is in said third setting, one of said self-recorded audio files is played over said speaker each time one of said touch sensors is activated.

2. The method according to claim 1, wherein when said at least one control switch is in said second setting, audio received by said microphone is recorded in said memory each time one of said touch sensors is activated, and said self-recorded audio files that are created are specific to which of said touch sensors was activated during the recording of said self-recorded audio files.

3. The method according to claim 2, wherein when said at least one control switch is in said third setting, a self-recorded audio file made for a specific touch sensor is played over said speaker when said specific touch sensor is activated.

4. The method according to claim 1, wherein said memory is a dynamic memory having a memory capacity that can be dynamically distributed to all of said self-recorded audio files.

5. The method according to claim 1, wherein said touch sensors are capacitive pressure sensors.

6. The method according to claim 1, further including a volume control accessible on said book structure to control a volume of said speaker.

7. The assembly according to claim 1, wherein at least one of said touch sensors is provided on each of said book pages.

8. A method, comprising:
providing a book structure that contains a plurality of pages and at least one compartment, wherein said compartment contains a memory, a microphone, and a speaker, wherein said memory contains RAM circuitry and ROM circuitry;
providing a touch sensor on each of said plurality of pages;
providing at least one control switch on said book structure, wherein said at least one control switch can be selectively configured into a first setting, a second setting, and a third setting;
wherein when in said first setting, a preset audio file from said ROM circuitry is played over said speaker each time said touch sensor is activated;
wherein when in said second setting, audio is recorded in said RAM circuitry each time said touch sensor is activated, therein creating a self-recorded audio file; and
wherein when in said third setting, said self-recorded audio file is played over said speaker each time said touch sensor is activated.

9. The method according to claim 8, wherein said memory is a dynamic memory for storing said self-recorded audio file for each said touch sensor on each said book page, wherein said dynamic memory has a memory capacity that can be dynamically shared.
